(19) United States
(12) Patent Application Publication
(10) Pub. No.: US 2009/0258557 A1
(43) Pub. Date: Oct. 15, 2009

(54) Textile substrates exhibiting enhanced antifungal attributes

(76) Inventor: William C. Kimbrell, Spartanburg, SC (US)

Correspondence Address: Legal Department (M-495), P.O. Box 1926, Spartanburg, SC, 29304, US

(21) Appl. No.: 12/082,872

(22) Filed: Apr. 15, 2008

(51) Int. Cl. B32B 5/02; D03D 25/00; B05D 3/00

(52) U.S. Cl. 442/123; 427/372.2

(57) ABSTRACT

This invention relates to the field of industrially launderable textile substrates possessing enhanced antifungal attributes. Specifically, the instant invention relates to industrially launderable textile substrates such as napery items, bar towels, shower curtains, and uniforms that possess antifungal properties, said antifungal properties being retained after multiple industrial laundering cycles.

### FIELD OF THE INVENTION

This invention relates to the field of industrially launderable textile substrates possessing enhanced antifungal attributes. Specifically, the instant invention relates to industrially launderable textile substrates such as napery items, bar towels, shower curtains and uniforms that possess antifungal properties, with the antifungal properties being retained after multiple industrial laundering cycles.

### BACKGROUND

Microbial contamination and growth may occur on a variety of textile substrates. Bacteria and fungal contamination have been linked to odors, stains, strength loss and other adverse effects on the textile substrates. The large surface area inherent in textile substrates, the types of stains and finishes present on said textiles and the use and storage practices of said soiled textiles before a cleaning operation all contribute to the growth of bacteria and fungal species. For example, in the case of rental napery products, it is the common practice of users of the napery products (e.g. restaurants, etc.) to put used napery items in a laundry bag or other collection device where they are held until the rental laundry makes its next product pickup. As one can imagine, the napery articles often contain bits of food or other organic matter, and are often moist or wet as well. The collection devices are in many cases left outside, where they may be exposed to additional moisture and/or a variety of temperatures. Since many bacteria and fungi thrive in a moist, warm environment, particularly where there is adequate food, in many cases these circumstances cooperate to provide an idyllic location for their rapid growth.

Soiled rental napery items are typically then collected by the rental laundries, and taken back to a facility where they are washed using what is commonly

Soiled rental napery items are typically then collected by the rental laundries, and taken back to a facility where they are washed using what is commonly known as an industrial laundering process. As noted above, the items may sit for a period of time (typically days at a time) until they are laundered. Industrial laundering is a wash process performed at higher temperature and/or pH levels (i.e. highly alkaline) than typical home washings. Such industrial wash processes can tend to be harsh, and can reduce the life of the textile products. In addition, many fabric treatments that will withstand home laundering do not stand up to industrial laundering. Nonetheless, it is believed that the industrial wash processes are required in order to ensure product cleanliness. However, in the case of many fungi, the industrial laundering process is insufficient to remove the stains they produce. In that case, bleach must also be used to try to eliminate the stains. However, bleach is known to oxidize many of the dyestuffs used to color the industrially launderable products, resulting in product color fading. In addition, using bleach and/or industrial laundry-applied biocide treatments with each wash increases the processing cost to the laundries.

Various antimicrobial technologies have been developed and applied to textiles in an attempt to reduce the incidence of fungus and bacteria growth on textile products. However, such techniques have proven to be insufficient for a number of products such as those that will undergo industrial laundering processes since they are not durable through repeated industrial launderings. In addition, industrially launderable products often contain a significant amount of polyester fibers, and such fibers do not possess sufficient hydroxyl or other chemical groups for typical chemical bonding, further compound the challenge of providing an antifungal treatment that is durable to industrial laundering. One attempt by the instant inventor to solve these issues involved the application of at least about 0.1% owf of diiodomethyl-4-tolylsulfone (40% active) to a substrate comprising polyester fibers and heating the treated substrate to a temperature sufficient to cause the diidomethyltolyl sulfone to penetrate the fibers but below the temperature that would volatilize or decompose the diidomethyltolyl sulfone or melt or damage the polyester fiber. While XRF data seemed to indicate sufficient diidomethyltolyl sulfone was retained through 50 industrial launderings, the products did not actually perform sufficiently in the field. While not intending to be bound to a particular theory, it is believed that the discrepancy may indicate the active ingredient of the chemical treatment penetrated the fiber but was unable to migrate back to the surface at an effective rate. Therefore, despite the existence of various antibacterial and antifungal treatments, to the inventor's knowledge there are no commercially available industrially launderable textile substrates or products having durable antifungal properties.

### DETAILED DESCRIPTION OF THE INVENTION

The present invention relates to industrially launderable textile substrates and articles possessing enhanced antifungal attributes. Said textile substrates are less prone to damage, such as stains, caused by fungal growth, and the antifungal characteristics are durable through a number of industrial launderings.

In the context of this disclosure, a number of terms shall be utilized. For purposes of this application, the term “antifungal” shall mean the product is capable of destroying, inhibiting the growth of, or preventing the growth of fungi. By textile substrates, it is meant fibers, yarns, fabric and the like. Fibers are meant to include natural and synthetic shaped polymeric articles, as known in the art. Yarns may comprise monofilaments, multifilaments and staple fibers, as known to those skilled in the art. Fabrics are intended to include knit, woven and nonwoven constructions, as known in the art.

Industrial laundering is intended to encompass techniques known in the industry for washing industrial goods, such as rental uniforms, napery, bar towels, and the like. Typically said industrial laundering is relatively harsh, as compared to home laundering. Said industrial laundering may comprise the use of higher temperatures, higher pH, larger loads that may contribute to increased abrasion and harsher detergents than used for typical home laundering procedures. By way of example, temperatures of 160° F. and a pH of 12 may be typical of industrial laundering. Said conditions are capable of hydrolyzing many chemical bonds and removing many textile finishes from the surface of fibers. In addition said harsh laundering conditions are known to remove dyes and other chemicals from the fibers, including dyes and chemicals from the interior of the fiber.

The inventor has surprisingly found a practical, cost effective solution to the issues of fungal growth (such as mold and mildew) on textile substrates that are cleaned by industrial laundering procedures. Said novel solution allows the textile substrates and articles to inhibit the growth of mold and mildew during the use cycle of the product and remain effective after a significant number of industrial laundering cycles.

The industrially launderable textile substrate desirably includes a polyester fibers, preferably consisting essentially of or entirely of polyester. The polyester fibers can be staple or filament fibers, or the substrate can include a combination thereof.

The fiber component is desirably formed into a fabric, and treated with the antifungal treatment, such that the antifungal treatment is diffused into the polyester fibers. The antifungal treatment desirably includes about 0.05% to about 2.4% diiodomethyl-4-tolylsulfone (40% active), and about 0.2% to about 0.8% zinc pyrithione (approximately 50% active) or polyaminopropyl biguanide (20% active) on weight of fabric (“owf”). Surprisingly, it was discovered by the instant inventor that by applying this combination of chemistries in a particular manner, a synergistic effect was achieved, providing durable performance through a large number of industrial launderings. In fact, the instant invention has achieved a level of durable performance not previously achievable through use of either of the agents alone or by other known antifungal agents.

The antifungal agents should be utilized at levels that are effective against the target organism, such as aspergillius niger. Preferably, the antifungal agent is applied in a concentration to achieve a concentration of about 0.05% to about 2.4% diiodomethyl-4-tolylsulfone (40% active), and about 0.2% to about 0.8% of zinc pyrithione (approximately 50% active) or polyaminopropyl biguanide (20% active) owf. In another aspect of the invention, the antifungal treatment will include about 0.2 to about 0.5% diiodomethyl-4-tolylsulfone (40% active), and about 0.3% to about 0.8% of zinc pyrithione (approximately 50% active) or polyaminopropyl biguanide (20% active) owf. In another preferred embodiment, about 0.5% diiodomethyl-4-tolylsulfone (40% active) and about 0.8% zinc pyrithione (approximately 50% active) or polyaminopropyl biguanide (20% active) owf are used. As noted, in trial work, zinc pyrithione (approximately 50% active) gave even better performance than polyaminopropyl biguanide (20% active), but both performed well within the antifungal treatment of the invention. There are certain upper limits of use for the antifungal agent that should not be exceeded due to environmental and toxicological considerations. In addition, additional antifungal and/or antibacterial agents are contemplated for use in combination with the treatment this invention.

With respect to the process, the steps include applying the antifungal agent to the surface of the textile substrate and applying heat, or other energy, to cause the antifungal agent to penetrate (diffuse into) the polyester fibers of the textile substrate. This will be achieved through exposure to heat. It has been found that exposure to temperatures of at least about 300° F. for at least 1.5 minutes is sufficient to diffuse the antifungal agent into the fibers. Temperatures of about 375° F. to about 400° F. have been found to achieve good penetration of the antifungal without adverse degradation of the treatment. As will be appreciated by those of ordinary skill in the art, the heat temperatures and exposure times will be optimized based on the equipment being used, running speeds, and substrate wetness, since these can affect the amount of time needed to achieve diffusion of the antifungal agent into the fibers.

The application of the antifungal agent to the surface of the textile can be accomplished by textile processes including but not limited to: adsorption as from a dye bath, padding, spraying, foaming, printing or any other technique known in the art for applying chemicals to the surface of textile substrates in a substantially uniform manner. Padding, such as immersion padding followed by passing the substrate between squeeze rolls to control the amount of chemical applied, may be a preferred procedure.

The application of heat or other energy to cause the antifungal agent to penetrate the fiber can be accomplished by traditional techniques known to those skilled in the art. Such techniques may include, but are not limited to: dry heat such as from a tenter oven, steam, microwave energy, infrared driers, etc. The preferred technique is the use of dry heat such as from a tenter frame. A preferred temperature range for polyester is desirably at least about 300° F. A more preferred temperature range may be about at least about 325° F. and the most preferred temperature may be between about 375-400° F. Said conditions for such alternatives can be determined empirically. Higher temperatures may lead to faster diffusion, but must remain below the volatization or decomposition temperature of the particular antifungal agent and below the melting point or decomposition temperature of the fiber. Likewise the time of exposure at said temperature can be varied from about 5 seconds to several minutes, such as 5 minutes. As stated previously, higher temperatures should require less time for the antifungal agent to penetrate the fiber. In addition, it may be preferable for the diffused antifungal agent to be near the surface of the fiber instead of uniformly distributed throughout the fiber. Such location may enhance migration of the antifungal agent to the surface of the fiber. Lower temperatures and shorter time exposure would favor this situation.

Textile substrates treated in accordance with the present invention have surprisingly been found to inhibit the growth of fungi on the surface of said substrates, even when tested under the rigorous conditions outlined below. Furthermore, it has surprisingly been found that the antifungal characteristics are durable to repeated industrial launderings, a characteristic heretofore not previously achievable in the industrial laundry market. As noted above, the growth of bacteria and fungi on the surface of textile substrates is known to present various issues related to the use of said textile. Included within these issues are stains, odors and loss of performance of the textile. Uses for such treated textile substrates may include various industrially launderable articles such as napery, industrial uniforms, aprons, chefs coats, shower curtains, bar towels, and the like. Of particular importance are those industrially launderable articles that have a tendency to be stored for a period of time in a soiled and/or moist condition before they are laundered.

### EXAMPLES

The following examples further illustrate the present invention but are not to be construed as limiting the invention as defined in the claims appended hereto. All parts and percents given in these examples are by weight unless otherwise indicated.

### Chemicals:

AMICAL Flowable™ is diiodomethyl-4-tolylsulfone (40% active) available from The Dow Chemical Company
Polyester resin used as a handbuilder (“HB”)
Fluorinated stain release agent (“FSRA”)
Ethoxylated polyester stain release agent (“SRA”)
Zinc OMADINE® is zinc pyrithione (approximately 50% active) (=50% active) available from Arch Chemicals, Inc.
Reputex 20 is polyaminopropyl biguanide (20% active) (20% active) manufactured by Avecia and available from Arch Chemicals, Inc.
Permafresh MFX is a substituted Dimethylol dihydroxyethylene urea resin (permanent press resin binder) available from Omnova (“Resin”)
Catalyst 531 is an aqueous magnesium chloride solution available from Omnova Blocked diisocyanate cross-linking agent (“Xlink”)

### Fungal Testing:

All testing was performed by modified ISO 846 Test Method as follows:

≈2.75 inch diameter circles from each test specimen were placed into sterile Petri dishes without agar
0.50 ml of fungal test solution was pipetted onto center of test specimen:
10E5 spores/ml concentration in ISO 846 basic mineral salt solution with glucose Test organism is believed to be penicillium species, cultured from a used Signature napkin (also tested against Aspergillius niger with similar results). The species that we cultured appears more indicative of the actual mold & mildew issue seen in the market! Petri dishes, containing inoculated samples were closed, placed into sealed Tupperware® plastic containers with a wet paper towel on the bottom of the container, and put into incubator at 30° C. and examined after 7 & 14 days. We took photographs after 7 & 14 days.

### Industrial Laundering:

All industrial laundering was done in 35 lb. Milnor with a 23 pound load

Industrial linen colored cycle (160° F. wash), formula 2 (no bleach) using the following test method:

### Industrial Wash Procedures:

Procedure #1 (23 lb. load in 35 lb. Milnor Washer):

| | | Temperature | Water | Chemical | Chemical |
|---|---|---|---|---|---|
| Operation | Time (Min) | (° F.) | Level | Usage | Name |
| Wash | 12 | 160 | Low | 3 oz. | Express |
| | | | | 3 oz. | Alpha |
| | | | | 2 oz. | Horizon |
| Carryover | 6 | 120 | Low | None | None |
| Rinse | 2 | 100 | High | None | None |
| Rinse | 2 | 80 | High | None | None |
| Rinse | 2 | Cold | High | None | None |
| Sour | 8 | Cold | Low | 0.5 oz. | Pinnacle |
| | | | | | Sour |
| Extract | 5 | Low Speed | None | None | None |

Chemicals Supplied by Washing Systems, Inc. of Cincinnati, Ohio:

### Express—Alkali

### Alpha—Detergent/Surfactant

### Horizon—Builder

Dryer: 50 pound gas dryer (15 minutes at Cotton High (190° F.), 5 minutes cool down

### Examples 1-6

≈14×14 inch samples of S/297625 woven polyester
(Style 297625: Plain weave 100% Polyester composed of:
12.0/1 100% T-510 Rieter R1 Open End 3.60 spun warp yarn
2/150/48 873T D/B textured polyester filling yarn
Weight: 6.15 oz/sq yd)
were padded through mixes containing:

| | | | Grams Zinc | Grams |
|---|---|---|---|---|
| Example | Grams Water | Grams Amical | Omadine | Reputex 20 |
| 1 | 200 | 0 | 0 | 0 |
| 2 | 198.7 | 1.3 | 0 | 0 |
| 3 | 197.9 | 0 | 2.1 | 0 |
| 4 | 197.4 | 0 | 0 | 2.6 |
| 5 | 196.6 | 1.3 | 2.1 | 0 |
| 6 | 196.1 | 1.3 | 0 | 2.6 |

The pad pressure was set at 40 psi, resulting in 78% wet pick-up on weight of the fabric.

After padding, the samples were dried and cured in a Despatch oven at 375° F. for 5 minutes. It is noted that prior uses of the antifungal chemistries discuss drying on the substrate to which they are applied at conventional drying temperatures, which are generally from about 200° F.-300° F. (with 225-250° being standard.)

After treatment with the above formulas and industrial laundering for the number of cycles listed below, fungal test growth results after 7 day test are given in the table below:

| Example | No Wash | 5 Ind. Wash | 10 Ind. Wash | 20 Ind. Wash |
|---|---|---|---|---|
| 1 | Severe | NE | Severe | Severe |
| | Growth | | Growth | Growth |
| 2 | No Growth | Severe | Severe | Severe |
| | | Growth | Growth | Growth |
| 3 | No Growth | No Growth | Severe | NE |
| | | | Growth | |
| 4 | No Growth | Severe | Severe | NE |
| | | Growth | Growth | |
| 5 | No Growth | No Growth | No Growth | No Growth |
| 6 | No Growth | 1 small spot | No Growth | No Growth |

As can be seen in the table above, all of the antimicrobials tested were satisfactory at inhibiting fungal growth on the fabric before laundering. However, only combinations of Amical with Zinc Omadine or Reputex 20 were effective at inhibiting fungal growth after relatively few industrial laundering cycles. This result (that combinations of antimicrobial chemistries have a pronounced effect on the durability of the fungal inhibition properties of the treated substrate after multiple industrial laundering cycles) is totally unexpected and quite surprising!

### Examples 7-12

The same fabric used above was treated in like manner with the formulas below:

| Example | Water | Amical | HB | FSRA | SRA |
|---|---|---|---|---|---|
| 7 | 200 grams | X | X | X | X |
| 8 | 198.7 grams | 1.3 grams | X | X | X |
| 9 | 194.5 grams | 1.3 grams | 2.5 grams | 0.50 grams | 1.2 grams |
| 10 | 193.2 grams | 2.6 grams | 2.5 grams | 0.50 grams | 1.2 grams |
| 11 | 190.6 grams | 5.2 grams | 2.5 grams | 0.50 grams | 1.2 grams |
| 12 | 185.4 grams | 10.4 grams | 2.5 grams | 0.50 grams | 1.2 grams |

Samples were tested for mildew inhibition after 10 standard industrial laundering cycles. Results are shown in the table below:

| Example | Test Results @ 7 Days | Test Results @ 14 Days |
|---|---|---|
| 7 | Severe Growth | Severe Growth |
| 8 | Severe Growth | Severe Growth |
| 9 | Severe Growth | Severe Growth |
| 10 | Severe Growth | Severe Growth |
| 11 | Severe Growth | Severe Growth |
| 12 | Severe Growth | Severe Growth |

As can be seen in these examples, Amical shows no efficacy against fungal growth after 10 industrial launderings, even at high concentrations. In addition, the polymeric handbuilder and stain release agents do not enhance the durability of the Amical nor do they appear to hinder performance of the antifungal agents.

### Examples 13-18

The three antimicrobials used before were applied with and without cross-linking chemistry that would be expected to increase the durability of the chemistry to industrial laundering. The substrate and process parameters were the same as used before. The mixes contained the following:

| Exam- | | Anti- | | | | | Cat. | |
|---|---|---|---|---|---|---|---|---|
| ple | Water | microbial | HB | FSRA | SRA | Resin | 531 | Xlink |
| 13 | 194.5 | 1.3 | 2.5 | 0.5 | 1.2 | X | X | X |
| | | Amical | | | | | | |
| 14 | 188 | 1.3 | 2.5 | 0.5 | 1.2 | 5.0 | 1.0 | 0.5 |
| | | Amical | | | | | | |
| 15 | 193.7 | 2.1 Zinc | 2.5 | 0.5 | 1.2 | X | X | X |
| | | Omadine | | | | | | |
| 16 | 187.2 | 2.1 Zinc | 2.5 | 0.5 | 1.2 | 5.0 | 1.0 | 0.5 |
| | | Omadine | | | | | | |
| 17 | 193.2 | 2.6 | 2.5 | 0.5 | 1.2 | X | X | X |
| | | Reputex | | | | | | |
| | | 20 | | | | | | |
| 18 | 186.7 | 2.6 | 2.5 | 0.5 | 1.2 | 5.0 | 1.0 | 0.5 |
| | | Reputex | | | | | | |
| | | 20 | | | | | | |

Samples were tested for mildew inhibition after 10 standard industrial laundering cycles. Results are shown in the table below:

| Example | Test Results @ 7 Days | Test Results @ 14 Days |
|---|---|---|
| 13 | Severe Growth | Severe Growth |
| 14 | Severe Growth | Severe Growth |
| 15 | Severe Growth | Severe Growth |
| 16 | Severe Growth | Severe Growth |
| 17 | Severe Growth | Severe Growth |
| 18 | Slight Growth | Growth |

As can be seen, even the addition of multiple cross-linking chemistries did not result in mildew inhibition after 10 industrial laundering cycles.

### Examples 19-22

The same fabric previously used was treated in like manner with combinations of antimicrobial agents. The mixes contained the following:

| | | | | | | Zinc | Reputex |
|---|---|---|---|---|---|---|---|
| Example | Water | Amical | HB | FSRA | SRA | Omadine | 20 |
| 19 | 194.5 | 1.3 | 2.5 | 0.5 | 1.2 | X | X |
| 20 | 192.4 | 1.3 | 2.5 | 0.5 | 1.2 | 2.1 | X |
| 21 | 191.9 | 1.3 | 2.5 | 0.5 | 1.2 | X | 2.6 |
| 22 | 191.8 | X | 2.5 | 0.5 | 1.2 | 2.0 | 2.0 |

Samples were tested for mildew inhibition after 10 standard industrial launderings. Results are shown in the table below:

| Example | Test Results @ 7 Days | Test Results @ 14 Days |
|---|---|---|
| 19 | Severe Growth | Severe Growth |
| 20 | No Growth | No Growth |
| 21 | No Growth | 1 small spot |
| 22 | Severe Growth | Severe Growth |

As can be seen in the above Table, combinations of Amical with Zinc Omadine or Reputex 20 surprisingly provide durable inhibition of mildew growth. Combinations of Zinc Omadine and Reputex 20 did not provide durable inhibition of mildew growth.

### Examples 23-27

Example 20 was repeated, except the temperature for drying and curing was varied. Results are shown in the table below for mildew inhibition after 5 standard industrial laundering cycles:

| | | Test Results @ |
|---|---|---|
| Example | Test Results @ 7 Days | 14 Days |
| 23 (250° F. for 5 minutes) | Severe Growth | Severe Growth |
| 24 (300° F. for 5 minutes) | 1 Tiny Spot | Growth |
| 25 (325° F. for 5 minutes) | No Growth | No Growth |
| 26 (350° F. for 5 minutes) | No Growth | No Growth |
| 27 (375° F. for 5 minutes) | No Growth | No Growth |

As can be seen in the above Table, higher temperature for the dry/diffusion process enhances the durability of the mildew inhibition against industrial laundering. If sufficient temperature is not achieved, such as a low temperature to only remove the liquid, then durability to industrial laundering is not achieved!

### Examples 28-31

Example 20 was repeated on other textile fibers. After treatment and mildew inhibition testing, the results are shown in the table below:

| | Test Results @ | Test Results @ |
|---|---|---|
| Style | 7 Days | 14 Days |
| Example 28: Signature | No Growth | No Growth |
| by Milliken ® (Spun & | | |
| filament PET) | | |
| Example 29: Encore ™ | No Growth | No Growth |
| by Milliken(All filament PET) | | |
| Example 30: Poly/Cotton | Growth | Severe Growth |
| Example 31: Nylon | Severe Growth | NE |

Ex. 28 fabric was the same as in Ex. 20.

Ex. 29 fabric was a 100% polyester filament plain weave of the variety sold my Milliken & Company under the brand ENCORE. It had 1/300/136 false twist texture yarns in the warp direction, and 3/150/68 false twist textured yarns in the filling direction, and was woven with 60 ends per inch and 46 ends per inch. It had a weight of about 6 oz/sq yard.

Ex. 30 fabric was a polyester/cotton blend fabric. The warp yarns were made of 14.0/1 open end spun 65/35 polyester/cotton staple fibers with 3.30 twist multiple. The filling yarns were made of 12.0/1 open end spun 65/35 polyester/cotton staple fibers with 3.25 twist multiple. The polyester staple fibers for both the warp and filling yarns had a denier of approximately 1.2. The warp and filling yarns were woven together in a 3×1 left hand twill pattern having 100 warp yarns and 47 filling yarns per inch of fabric. The fabric was subsequently dyed via a continuous dyeing process, and had a weight of about 8.5 oz/sq yard.

Ex. 31 used a nylon fabric commercially available from Milliken & Company. The warp yarns were 70/34 denier filament nylon 6, 6 fibers, and the filling yarns were 2/070/66 denier filament nylon 6,6 fibers. Warp and fill yarns were woven together in a plain weave pattern having 106 warp yarns and 68 filling yarns per inch of fabric. The fabric was jet dyed and then face finished by light exposure to mechanical sanding. The finished fabric had a width of about 60 inches and a weight of about 4.8 oz/sq yard.

These examples indicate that fiber selection is an important parameter. Without being bound by theory, the results may indicate that diffusion into and out of the fiber could be a mechanism that accounts for the enhanced durability of the inhibition of mold and mildew after industrial laundering. It is entirely unexpected that combinations of antimicrobial agents would enhance diffusion into or out of the fiber!

### Examples: 32-37

Example 20 was repeated, except the ratio of Amical to the other antimicrobial was examined. Each mix contained all of the other components at the same level, but the amount of Amical, Zinc Omadine and Reputex 20 were varied as follows:

| | | | | Ratio of |
|---|---|---|---|---|
| | | Grams Zinc | Grams | Amical to Zinc |
| Example | Grams Amical | Omadine | Reputex 20 | or Reputex |
| 32 | 1.3 | 2.1 | X | 1:2 |
| 33 | 6.25 | 0.5 | X | 10:1 |
| 34 | 0.5 | 4.0 | X | 1:10 |
| 35 | 1.3 | X | 2.6 | 1:1 |
| 36 | 6.25 | X | 1.25 | 10:1 |
| 37 | 0.5 | X | 10 | 1:10 |

After treatment, 10 industrial laundering cycles and mildew inhibition testing, the results are shown in the table below:

| Example | Test Results @ 7 Day |
|---|---|
| 32 | No Growth |
| 33 | No Growth |
| 34 | No Growth |
| 35 | 1 Small Spot |
| 36 | Growth |
| 37 | Severe Growth |

These examples indicate that the ratio of Amical to Zinc Omadine can be varied over a broad range. While not as effective, the ratio of Amical to Reputex 20 can also be varied.

### X-Ray Fluorescence Analysis

### Overview:

XRF is a technique that examines materials for specific “inorganic” elements (Na-U), which may provide certain desired properties for our associates and customers. The makeup of a material or the presence of specific chemicals can often be determined by identifying the elements found in the sample. XRF is used to analyze a variety of samples such as treated fabrics, liquid matrices, films, unknown composition samples, powders or any solid matrices. XRF is also a non-destructive technique that allows for quick and accurate results, which makes it a valuable initial screening tool for looking at qualitative (relative) sample compositions and concentrations. XRF can be used for quantitative analysis but known prepared or purchased standards are needed.

### Instrumentation:

### Manufacturer—Thermo Noran

### Model—QuanX-EC Energy Dispersive X-Ray Analyzer

Rhodium target X-Ray tube (50 kv/2.0 mA)

### Electrically Cooled Detector (Solid State Si(Li))

### Test Method:

### Fabric Samples:

Drape one layer of fabric over sample cup (double sided cup #1530 Chemplex) and hold in place with sample cup ring clamp.

Place into sample chamber (load 20 at a time if needed).

For Zinc Analysis—run under “Air” setting and under filter (Mid Zb-Medium Palladium).
For Iodine Analysis—run under “Air” setting and under filter (High Zb-Thick Copper Analyze samples for 300 secs (˜50% Dead time)
Report x-ray counts in “net area cts”
Record counts in spreadsheet

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An industrially launderable textile substrate having durable antifungal characteristics after repeated industrial launderings, said textile substrate consisting essentially of polyester fibers, said fibers being formed into a textile fabric, wherein said textile substrate further comprises an antifungal treatment diffused into the polyester fibers, said antifungal treatment comprising diiodomethyl-4-tolylsulfone and zinc pyrithione or polyaminopropyl biguanide.

2. The textile substrate of claim 1, wherein said antifungal treatment comprises about 0.05% to about 2.4% diiodomethyl-4-tolylsulfone (40% active) and about 0.2% to about 0.8% zinc pyrithione (approximately 50% active) or polyaminopropyl biguanide (20% active) on weight of fabric.

3. The textile substrate of claim 1, wherein said textile substrate is woven.

4. The textile substrate of claim 1, wherein said textile substrate comprises spun polyester fibers.

5. The textile substrate of claim 1, wherein said textile substrate comprises filament polyester fibers.

6. The textile substrate of claim 1, wherein said textile substrate comprises both spun polyester fibers and filament fibers.

7. The textile substrate of claim 1, wherein the antifungal treatment comprises about 0.2% to about 0.5% of diiodomethyl-4-tolylsulfone (40% active) and about 0.3% to about 0.8% zinc pyrithione (approximately 50% active) or polyaminopropyl biguanide (20% active) on weight of fabric.

8. The textile substrate of claim 1, wherein the antifungal treatment comprises about 0.5% of diiodomethyl-4-tolylsulfone (40% active) and about 0.8% zinc pyrithione (approximately 50% active) or polyaminopropyl biguanide (20% active) on weight of fabric.

9. The textile substrate of claim 1, wherein the substrate is in the form of an article selected from the group consisting of an item of napery, a bar towel, a uniform, or a shower curtain.

10. A process of making an industrial wash durable antifungal textile substrate, wherein said process comprises the steps of:
providing a textile substrate, said substrate consisting essentially of polyester fibers
applying an antifungal treatment comprising about 0.05% to about 2.4% owf of diiodomethyl-4-tolylsulfone (40% active) and about 0.2% to about 0.8% owf of zinc pyrithione (approximately 50% active) or polyaminopropyl biguanide (20% active) to said textile substrate, and
heating said treated textile substrate to a temperature sufficient to cause the diiodomethyl-4-tolylsulfone (40% active) to penetrate the polyester fibers of said textile substrate, but below the temperature that would volatilize or decompose said diiodomethyl-4-tolylsulfone (40% active) or melt or damage said polyester fiber.

11. The process of claim 10, wherein the textile substrate having the antifungal treatment applied to it is heated to a temperature of at least about 300° F. for a period of time sufficient to cause at least some portion of said antifungal treatment to penetrate said fiber.

12. The process of claim 10, wherein the textile substrate having the antifungal treatment applied to it is heated to a temperature of about 300° F. for about 2 to about 5 minutes.

13. The process of claims 10, wherein the treated textile substrate having the antifungal treatment applied to it is heated to a temperature of about 375 to about 400° F. such that the antifungal treatment is diffused into the polyester fibers.

14. The process of claims 10, wherein the treated textile substrate having the antifungal treatment applied to it is heated to a temperature of about 375 to about 400° F. for a period of about 5 to about 90 seconds.

15. The process of claim 10, wherein other surface modifying agents selected from the group consisting of stain release agents, stain repellant agents, handbuilders, softeners, cross-linking agents, antistats, and flame retardants are applied to the textile substrate.
